(19) United States
(12) Patent Application Publication
(10) Pub. No.: US 2003/0217291 A1
(43) Pub. Date: Nov. 20, 2003

(54) Method and system for real-time secure transfer of personal information between websites

(75) Inventors: Susan Schramm-Apple, Hatfield, PA (US); Sean Dippold, Schwenksville, PA (US); Melanie Kittrell, Maple Glen, PA (US); Keith Bauer, Souderton, PA (US); Lori Moore, Lafayette Hill, PA (US)

Correspondence Address: HALE & DORR LLP, THE WILLARD OFFICE BUILDING, 1455 PENNSYLVANIA AVE, NW, WASHINGTON, DC, 20004, US

(73) Assignees: Merck & Company, Inc., Rahway, NJ (US); HALE AND DORR LLP

(21) Appl. No.: 10/390,159

(22) Filed: Mar. 18, 2003

Related U.S. Application Data
(60) Provisional application No. 60/364,743, filed on Mar. 18, 2002.

(51) Int. Cl. H04L 9/00

(52) U.S. Cl. 713/201; 709/250

(57) ABSTRACT

A method of securely transferring user information between a website server and at least one external website server to authenticate a user with the at least one external website server includes receiving a request for accessing an external website server by the user and determining whether the user is not logged on to the website server. If the user is not logged on, the user is logged on to the website server by the user. A secure connection from the website server to the at least one external website server is generated and the user information is transferred from the website server to the at least one external website server by a HTTP GET protocol and/or a HTTP POST protocol.

### CROSS REFERENCE TO RELATED APPLICATIONS

This application is related to and claims priority from U.S. Provisional Application Serial No. 60/364,743, filed Mar. 18, 2002 and incorporated herein by reference.

This application is related to the following U.S. patent applications: Attorney docket numbers 105456.121, 105456.124, 105456.125, 105456.126, and 105456.127, to the same inventors, and all of which are incorporated herein by reference.

### FIELD OF THE INVENTION

The present invention is directed to methods and systems for the secure transfer of information between servers, such as website servers. More particularly, it relates to methods and systems for transferring user information between a host website server and an external website server such that a user can be authorized to access an external website supported by the external website server.

### BACKGROUND OF THE RELATED ART

In the healthcare field, healthcare professionals conventionally may obtain information from medical publishers, with most of this information being just in print. On the other hand, academic institutions have considerable libraries, which unfortunately are not universally available to physicians. Hence, paper resources with healthcare information may be considerable but difficult to access.

In an attempt to provide information electronically, early websites with limited information were sponsored by a variety of commercial entities, academic institutions, or medical associations. There has been, nevertheless, a lack of awareness among physicians of the web as a resource for providing information and/or other resources needed by physicians. Premium resources might be provided on some of these sites, nevertheless, there was limited exposure and/or access to these premium resources for physicians and other healthcare professionals. These conventional means of providing information and other healthcare professional resources resulted in an uneven playing field for healthcare providers.

In addition, there are a number of other hurdles facing office-based, rural and non-institutional healthcare professionals. For example, physicians and other healthcare providers are presently adapted to the current situation. They are unlikely to change their current habits. Although there is a much greater degree of information available, unfortunately it will not find its way into the hands of physicians and healthcare providers, and ultimately will not result in improved healthcare. Nevertheless, the ability to save time and/or money is one of the primary motivators for physicians or healthcare professionals to change their habits.

Conventionally, the information and/or information gathering process is difficult and awkward for healthcare providers. The information might not be provided in one convenient place. Moreover, the information itself might be inconvenient. For example, if the information is provided by subscription, it is typically expensive to obtain multiple subscriptions. On the other hand information in textbooks might not be up-to-date. Further, textbooks, journals and libraries are not at all suited to physicians' nomadic working style, which typically includes travel between an office and a hospital. Information which might be provided over the web may be jumbled or confused, with multiple places, passwords, formats, browsers and search engines provided for a variety of information. Ultimately, physicians and other providers have entirely too many subscriptions, accounts, ID's and passwords, making the information awkward.

With regard to utilizing the Internet, the physicians might suspect the quality of information or services provided online. Moreover, such information and services might be biased, for example as a result of a sponsor of a particular product, unbeknownst to the users. Where information in sites is searchable, the search engines that are provided might not retrieve search results that are most relevant to the physicians' query.

In some situations, the access to information or services might be tied to a specific license or specialized access technology. For example, in order to obtain certain information or services, the physician might be required to use a specific computer or install certain technology.

In addition, sites that are provided by pharmaceutical companies do not tend to focus on physicians. These sites are product driven and patient oriented. They fail to provide for the needs of the physician as a customer. In short, it is difficult to obtain information or services via conventional methods.

One specific example of a website directed to physicians is Medscape/WebMD. Unbeknownst to physicians, however, Medscape/WebMD is commercially sponsored and exhibits a bias. As another example, this site gives physicians limited access to premium resources, such as the best journals and text, because there is no financial incentive to make this information available. Moreover, typical of these types of sites, Medscape/WebMD does not have access to the premium resources sufficient to place them online.

Meanwhile, physicians are facing an increasing number of pressures. These pressures on healthcare practitioners include an increase in time pressures, perhaps caused by busy practices and overwhelming paperwork. At the same time, healthcare practitioners face decreasing practice revenues. They also face information overload, with a decreasing amount of time to sort through the relevant information.

The inventors have determined that physicians or other healthcare professionals engage in a number of online activities, including literature searches, reading medical news in the professional press, reading professional journals, finding patient educational materials, using drug reference databases, researching upcoming meetings, engaging in online continuing medical education (CE), reading medical news in the lay press, communicating with colleagues, finding out about clinical trials, learning about medical devices, reading medical text, and/or participating in MD chat rooms. It is estimated by the inventors that online CE is engaged in by 58% and 51% of primary care providers and physician specialists, respectively.

The inventors have determined that physicians refer to medical information sites primarily to find news and reference materials. In one study by the inventors in responding to a question about the three most important factors a physician uses in determining which medical information sites to use, the following responses were provided:

| Description | Percent |
|---|---|
| Medline Literature Search | 64% |
| Medical News Updates and Alerts | 53% |
| Medical Journals | 47% |
| Drug Reference Database | 34% |
| Medical Textbooks | 30% |
| Continuing Education Online | 29% |
| Courses | |
| Patient Relationship Information | 20% |
| and Guides | |
| Clinical Trial Information and | 15% |
| Links | |
| Listing of Medical Organizations | 7% |
| and Meetings | |
| Financial and World News | 5% |
| Community and Messages Boards | 4% |

The inventors performed extensive research with physicians about website features and functionality, including advisory boards, one-on-ones and online user ability testing. The above table highlights the findings of the online usability test of 154 physician respondents.

According to the Online Physician Market Dynamics Study (ZIMENT), February/March 2001, (Q9), quality, credibility and ease of use are the most important features to physicians in an online service. The following are attributes that are important to specialists and primary care physicians:

Provides credible information

Provides quality information

Is easy to use*

Provides up-to-date health and medical information*

Enables effective research of usual cases or conditions

Is comprehensive

Offers premium medical resources not easily accessible elsewhere

Helps physicians communicate better with patients

Is available to doctors only and not general consumers

Offers ability to customize site based on preferences or specialty

Has a professional look and feel

Is unique from other sites (These attributes are less important to specialists than primary care physicians.)

A website that allows a physician to link to other, 3rd party websites for research may still suffer from the drawback that the physician will often have to reenter authorization information required for access to the 3rd party websites. This can be a time consuming process, especially if the physician is doing broad research and will be visiting many 3rd party websites during a single on-line session. A solution to this problem would be a method of transmitting authorization entered from a single login process on a main, host website, to any 3rd party websites.

Certain aspects of transmitting information between websites, or more particularly, between website servers, are illustrated by way of example in FIG. 1, also described in U.S. Pat. No. 6,092,121 (Bennett et al.), incorporated herein by reference.

Bennett et al. discloses a system that integrates data captured in heterogeneous information system and transmits that data securely over the Internet between multiple diverse servers. The system includes at least one local computer system, which electronically captures information input by a user of the computer system. The local computer system can access one or more remote servers via the Internet to form a dynamically reconfigurable wide area network (“WAN”). The remote servers electronically transfer data to heterogenous information system translated into their natural communications protocol and data format.

As illustrated in FIG. 1, in, for example, a retail automobile dealership environment, the dealer server 11 connects via the Internet 17 to various disparate servers. The connections may be made to various alternative servers selectable by the user or in an order of preference stored in the dealer server. For example, there are typically multiple financial institutions having multiple server sets, here represented by two such server sets 18.sub.1 to 18.sub.n and 24.sub.1 to 24.sub.n. Each participating bank, credit union or other financial institution would have at least one server connectable via the Internet 17. The user of the system selects one of these sites or an order of site preference to which loan application data and, ultimately, a loan contract are transmitted.

Also, there are typically multiple insurance institution servers, here represented by a set of such servers 19.sub.1 to 19.sub.n. In addition to these, the dealer server can also access via the Internet various databases, such as a credit bureau server 20, providing access to commercial credit bureaus to obtain the credit rating of a potential buyer, so-called “black book” and “blue book” databases connected to server 21 to assess trade-in values, and the state's Department of Motor Vehicles server 22 to verify registration and insurance information. In each case, the exchange server for the particular institution or data base is operable to electronically transfer the data received to their connected information systems translated into their natural communications protocol and data format.

Since the Internet is being used as a dynamically configurable WAN, some mechanism must be in place to track this dynamism. This need is filled by the name server 25, which contains the location of all servers currently active in the system. This data is passed to clients attempting to communicate with these servers. Since the Internet communication is secure, an encryption key server 28 is needed to handle key distribution of new and updated keys.

The system disclosed in Bennett et al. fails to provide a mechanism by which a host website server can securely pass user information that is required to authenticate a user to various, 3rd party, external websites, obviating the need for the user to logged in independently to each, individual, external website.

### SUMMARY OF THE INVENTION

It is one feature and advantage of the present invention to allow a user to access multiple websites after a single instance of entering authentication information.

It is another optional feature and advantage of the present invention to provide secure transfer of user information between websites using either a HyperText Transport Protocol (“HTTP”) Get message or an HTTP Post message.

These and other features and advantages of the present invention are achieved in a method of securely transferring user information between a website server and at least one external website server to authenticate a user with the at least one external website server. The method includes at least one of the sequential, non-sequential, or sequence independent steps of receiving a request for accessing the at least one external website server by the user and determining whether the user is not logged on to the website server. If the user is not logged on, the method also includes logging on to the website server by the user. The method further includes generating a secure connection from the website server to the at least one external website server and transferring the user information from the website server to the at least one external website server by a HTTP GET protocol and/or a HTTP POST protocol.

In another embodiment of the present invention, a system for securely transferring user information between a website and at least one external website to authenticate a user with the at least one external website is provided. The system includes a website server, supports the website and at least one external website server, which supports the at least one external website. The system also includes a wide area network. The wide area network facilitates the transferring of user information between the website server and the at least one external website server, provides a secure connection between the website server to the at least one external website server, and enables the transfer of the user information from the website server to the at least one external website server by at least one of a HTTP GET protocol and a HTTP POST protocol. The system also includes a user input that enables the user to provide the user information such that the user is capable of being authenticated with the website server. The system further includes a database, in data communication with the website server, wherein the database stores the user information.

There has thus been outlined, rather broadly, the more important features of the invention and several, but not all, embodiments in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These, together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

FIG. 1 is an illustration of a prior art system for transferring information between website servers;

FIG. 2 illustration a system for transferring user information between website servers, according to the present invention;

FIG. 3 illustrates a registration process according to the present invention;

FIGS. 4A and 4B illustrate an example of a registration page;

FIG. 5 illustrates an example of a registration retry page;

FIG. 6 illustrates a login procedure, according to the present invention;

FIG. 7 illustrates an example of a login page;

FIG. 8 illustrates two methods in which a user may access an external website, according to the present invention; and

FIG. 9 illustrates a process for securely transferring user information between website servers, according to the present invention.

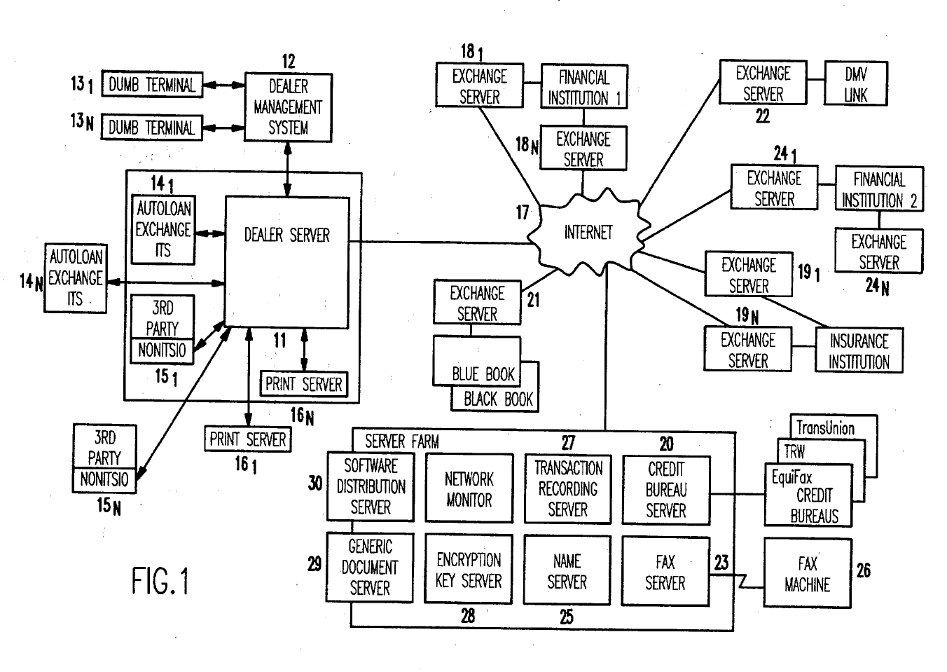

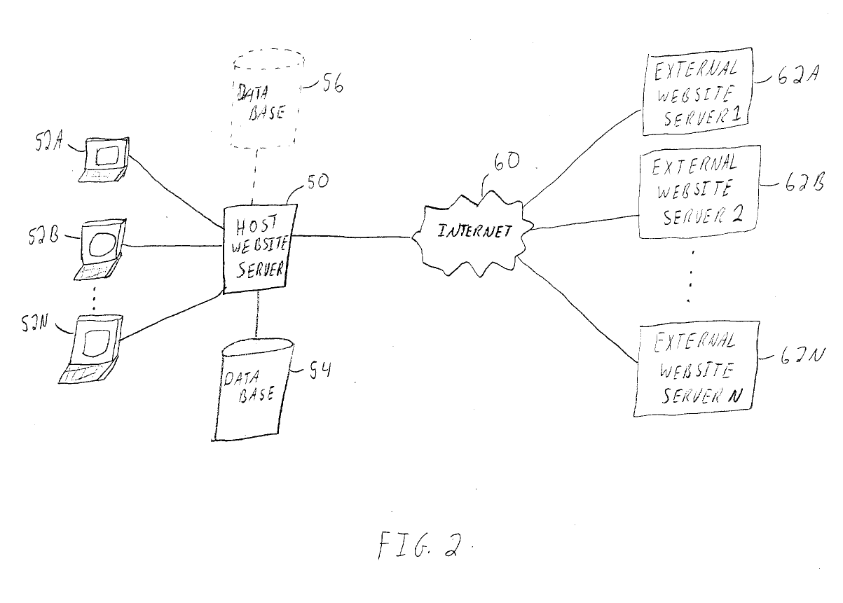

### DESCRIPTION OF THE PREFERRED EMBODIMENTS

Reference now will be made in detail to the presently preferred embodiments of the invention. Such embodiments are provided by way of explanation of the invention, which is not intended to be limited thereto. In fact, those of ordinary skill in the art may appreciate upon reading the present specification and viewing the present drawings that various modifications and variations can be made.

For example, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

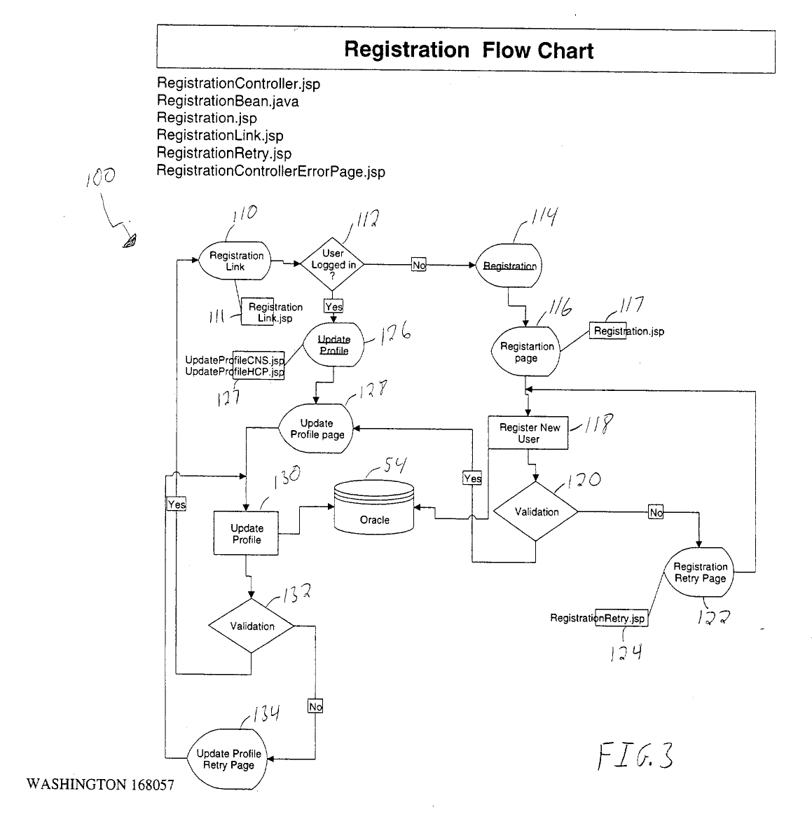

FIG. 2 illustrates the system of the present invention. Host website server 50 supports a host website, for example, the Merck Medicus website. A user, for example, a physician, accesses the host website through various user terminals, shown as user terminals 52A through 52N. The user, via the user terminal, navigates through the host website. Information entered by the user is stored, for example, in database 54. Additional information is optionally stored, for example, in a separate database 56.

The user can access an external, 3rd party website, through the host website, for example, by clicking on a link on the host website or by making an HyperText Transport Protocol (“HTTP”) request. Host website server 50 provides access to external website servers 62A through 62N by way of a wide area network (“WAN”), for example, the Internet 60.

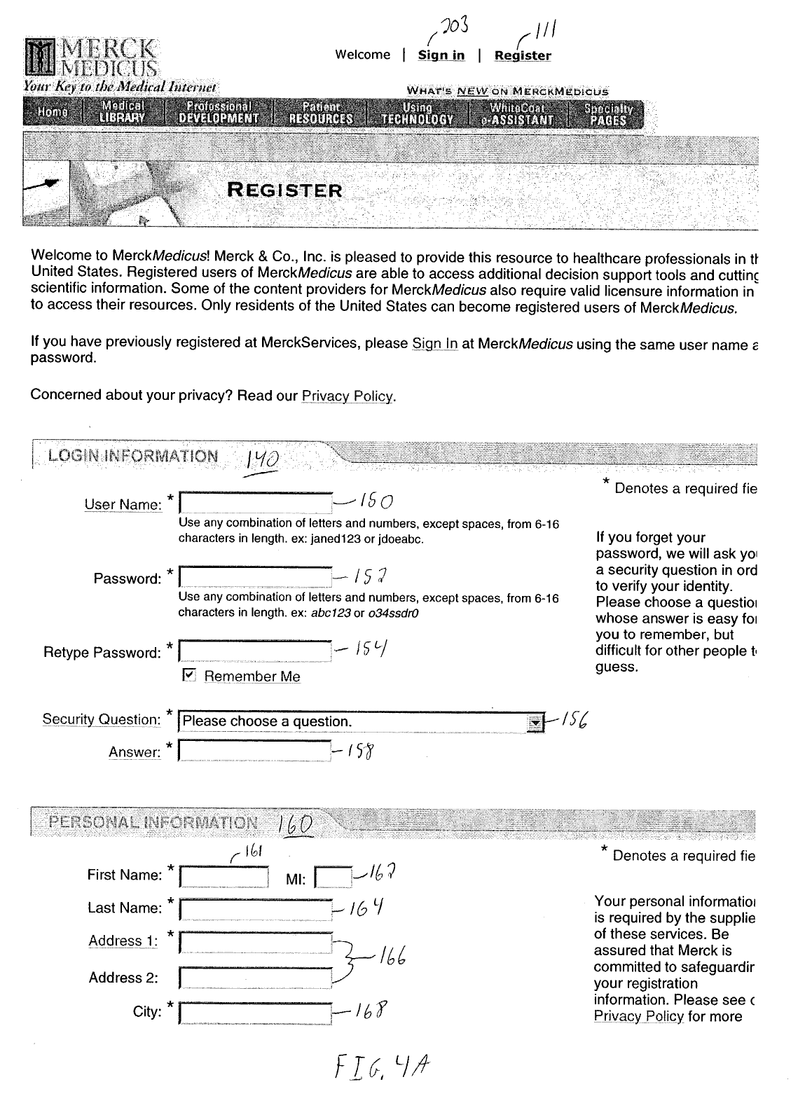

When a user, for example, a physician, initially accesses host website server 50, the user may register by entering login information and personal information. FIG. 3 illustrates the registration process. The user begins the process, denoted generally by reference numeral 100, by clicking on a registration link 111 located on the host website, step 110. For example, registration link 111 may be a Java Server Page (.jsp), which is a HyperText Markup Language (“HTML”) page with embedded Java source code that is executed in a Web server or an application server. The HTML provides the page layout that will be returned to the Web browser, and the Java provides the processing, for example, to deliver a query to a database and fill in blank fields in the database with results.

Host website server 50 determines whether the user is logged in, step 112. If the user is not logged in, the user is invited to complete the registration process, step 114.

The user is directed to registration page 117, step 116. The user registers, step 118, and host website server 50 determines whether the user is valid, step 120. Validation is described below in greater detail. If the user is not valid, the user is directed to a registration retry page 124, step 122. If the user is valid, host website server 50 then updates the user's profile page, step 128.

If the user is logged in, as determined in step 112, the user is given the opportunity to update his or her user profile data 127, step 126. Host website server then updates the user's profile page, step 128. Once the user's profile page is updated, the updated profile information is stored in, for example, database 54, which may be an Oracle database. Host website server 40 then determines whether the updated profile information is valid, step 132. If the updated profile information is not valid, the user is redirected to the profile update page and is prompted to reenter the updated profile information, step 134, after which the reentered information is again validated. If the updated profile information is valid, the registration process concludes and the user is returned to the page on which the registration link 111 was located.

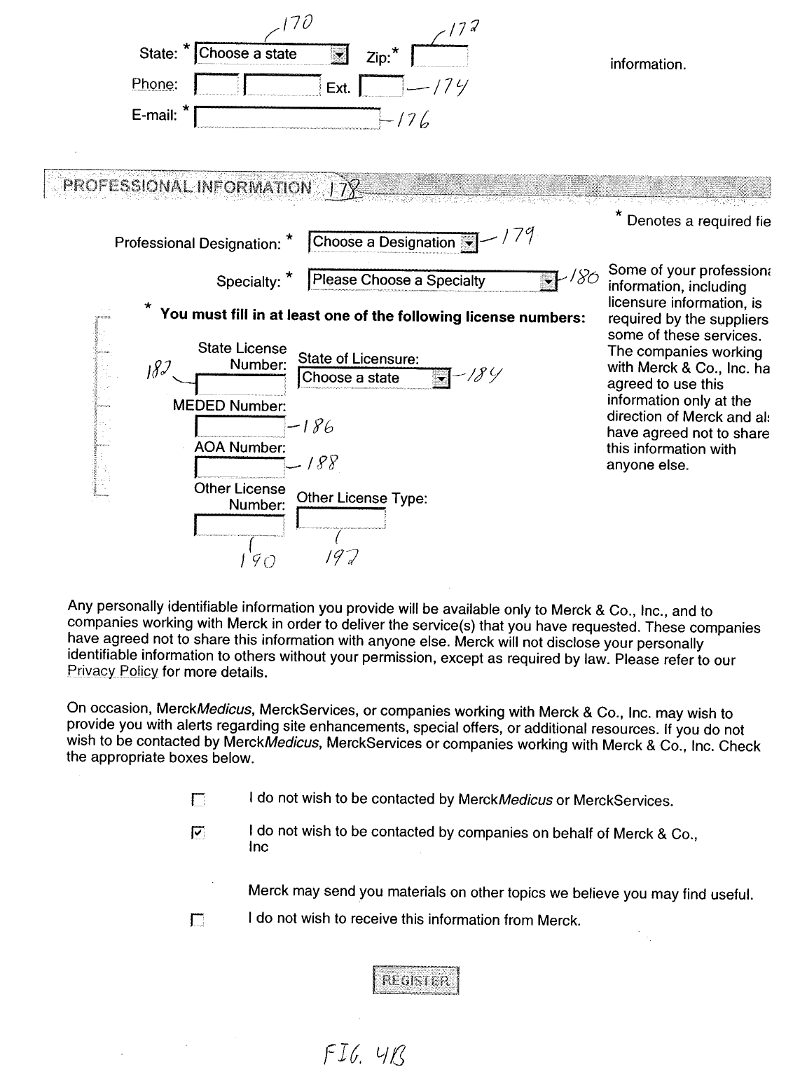

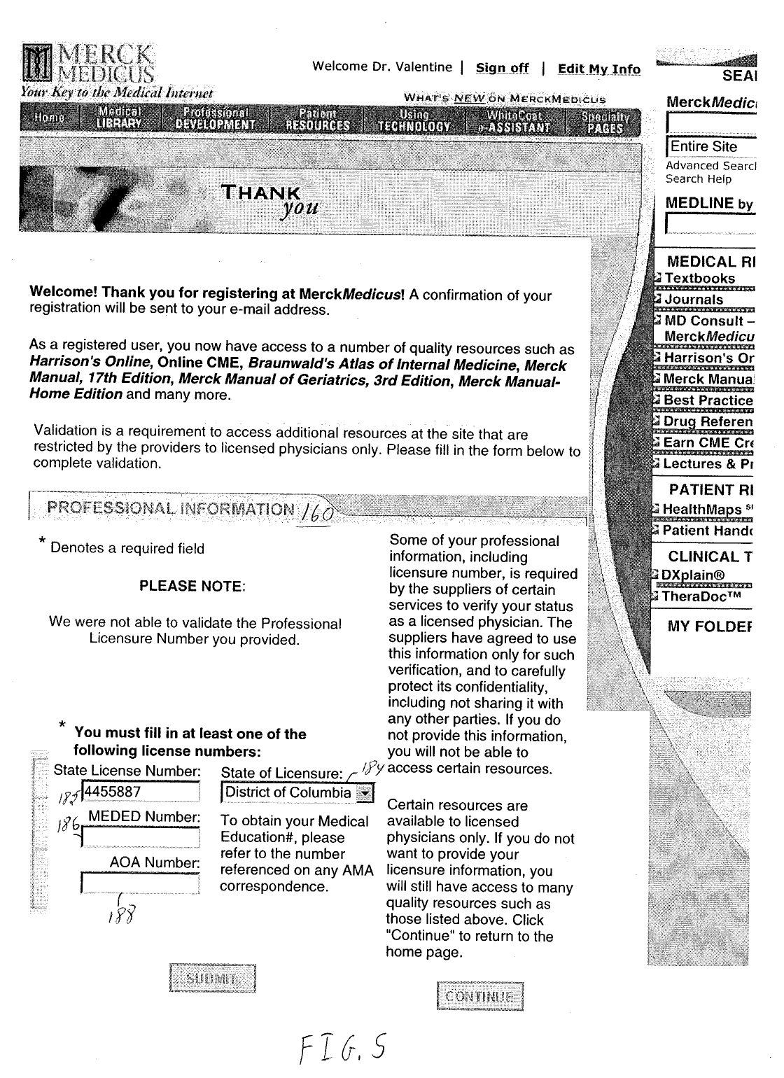

FIGS. 4A and 4B illustrate an example of a registration page 117. The user accesses registration page 117 through registration link 111, as seen towards the top of FIG. 4A. A new user may enter login information, such as a user name and a password, for future sessions, in Login Information section 140. The user can enter a user name in user name field 150 and a password in password field 152. For verification of the password, the user may reenter the chosen password in retype password field 154. The user may also choose a security question, using field 156, and an answer to the security question, using field 158, if the user forgets his or her password during a future login session.

Once the user has completed login information section 140, the user can enter personal registration information in personal information section 160. Personal information section 160 allows the user to complete, for example: first name field 161; middle initial field 162; last name field 164; address fields 166; city field 168; state field 179; zip code field 172; phone number fields 174; and e-mail address field 176.

Optionally, the user can also enter additional information for further authentication purposes, for example, a physician can enter professional information in section 178. Personal information section 178 may contain, for example: professional designation field 179; specialty field 180; state license number field 182; state of licensure field 184; Medical Education (“MEDED”) Number field 186; AOA Number field 188; other license number field 190; and other license type field 192. The user information entered in registration page 117 may be stored in database 54 along with the login information. Alternatively, the user information may be stored in a separate database from the login information, for example, database 56 (FIG. 2).

After the user has entered the information in registration page 117, host website server 50 validates the user information to determine, for example, whether the physician license number(s) is correct. If the information is not valid, the user is redirected to registration retry page 124, as illustrated in FIG. 5. Registration retry page 124 presents to the user, for example, professional information section 160 to allow the user to reenter various types of personal information. For example, the user may be prompted to reenter user information in state license number field 182, state of licensure field 184, MEDED number field 186, and/or AOA Number field 188. Once the information has been reentered, host website server 50 again attempts to validate the information. If the information is still not valid, the user may be returned to registration retry page 124. Otherwise the user may be presented with a message that the registration process failed and returned to a main page of the host website.

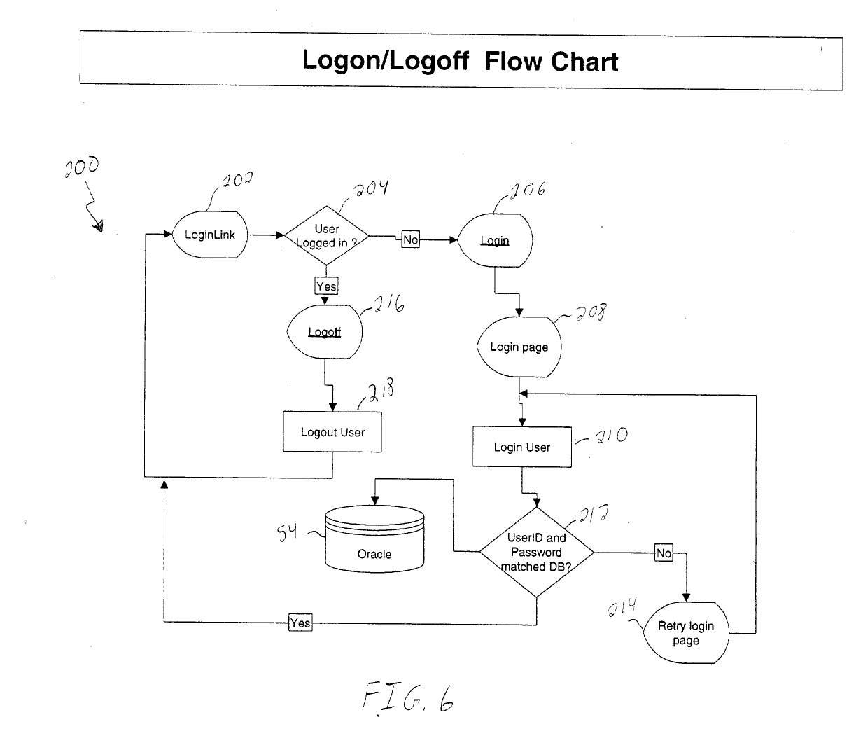

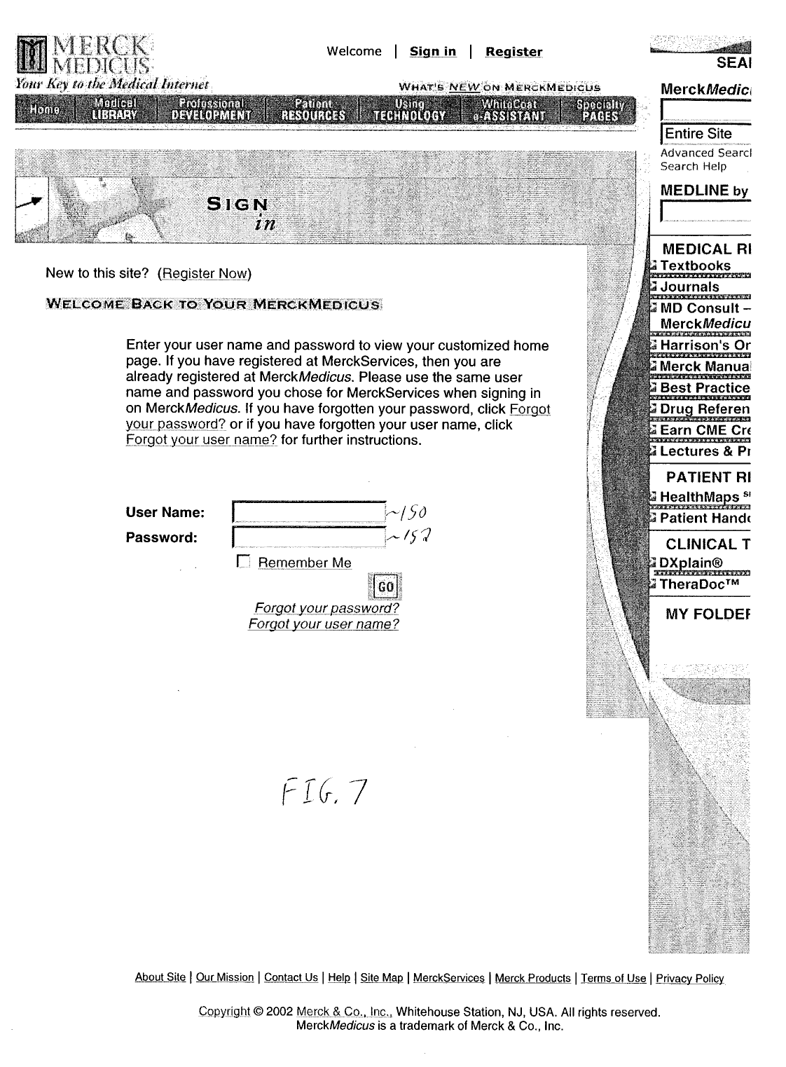

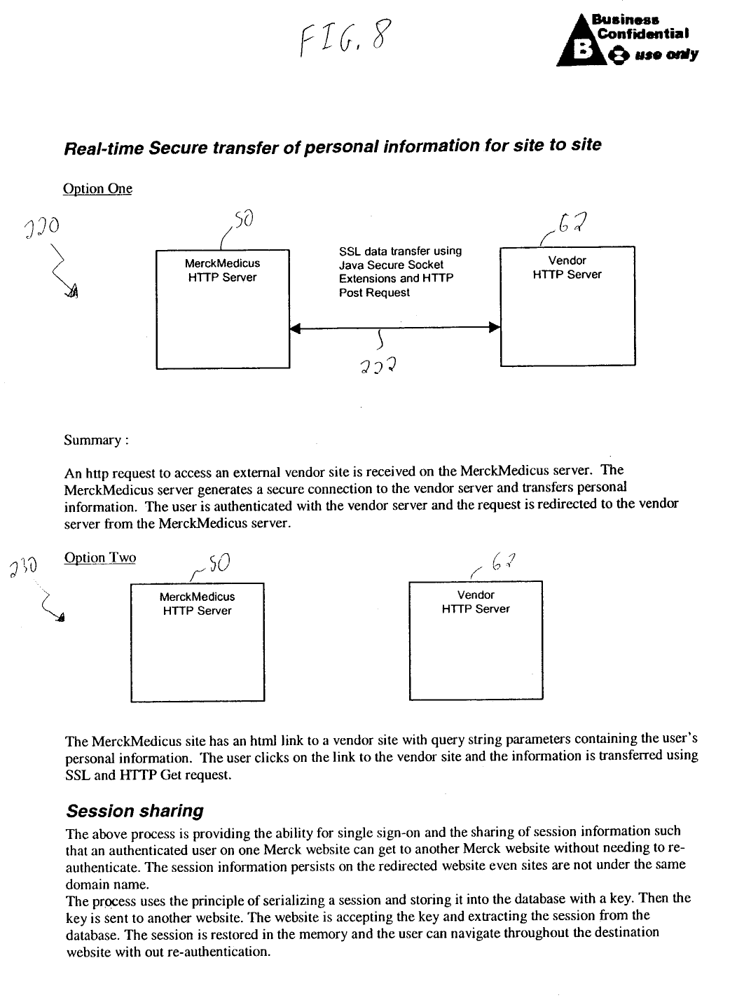

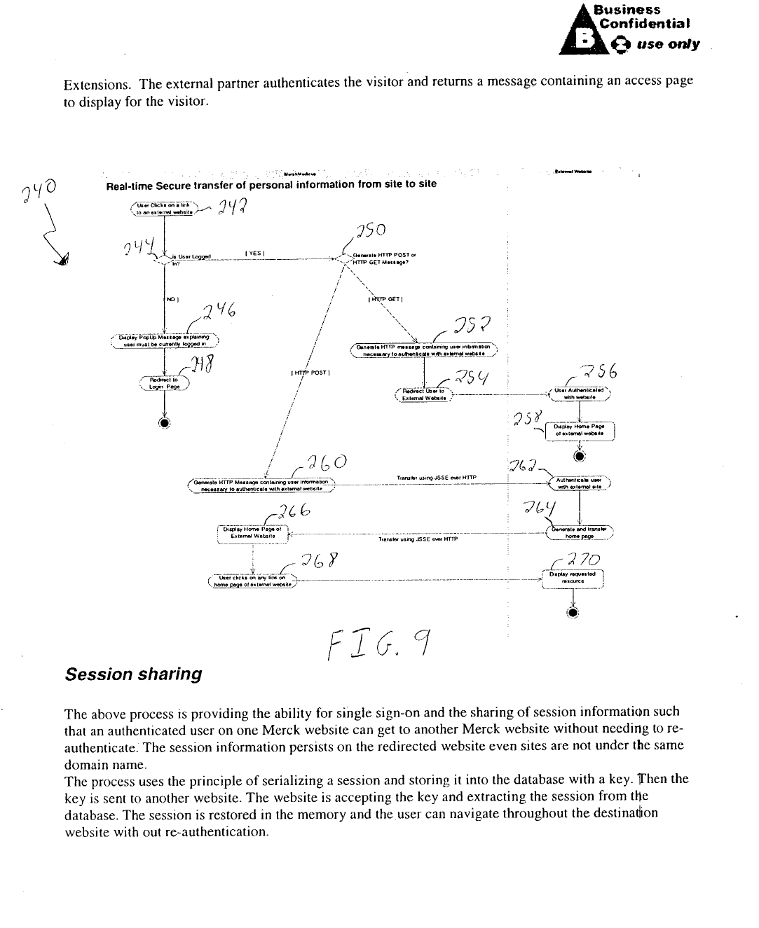

When a user returns to the host website during a subsequent session, the user may login to the site, thus allowing host website server 50 to access and retrieve the user's previously entered user information from database 54, or optionally, database 56. FIG. 6 illustrates the login procedure, denoted generally by reference numeral 200. The process begins when the user accesses a login link, for example, “Sign in” link 203 (FIG. 4A), step 202. Host website server 50 determines whether the user is already logged in, step 204. If the user is not already logged in, the user is directed to a login page, step 206, for example, the login page illustrated in FIG. 7. The login page has user name field 150 and password field 152, similar to the fields in login information section 140 (FIG. 4A).

The user completes the login page, step 208, and host website server 50 attempts to login the user, step 210. Host website server 50 determines whether the user name and password entered into the login page match login information stored in database 54, step 212. If a match for the user name and password are not located, the user is directed to reenter the login information, step 214. If a match is found in database 54, the user is logged onto the website, and host website server 50 is then capable of accessing the personal user information for that user stored in database 54, or alternatively, database 56.

If the user was already logged onto the host website, the user can start a logoff process by accessing the login link, step 202. The user is queried as to whether the user desires to logout, step 216, and the Host website server 50 logs out the user, step 218.

During a session, the user may desire to access an external website, example, to perform research beyond the capabilities of the host website. The external website may require authentication information to allow the user to access the external website. Rather than requiring the user to reenter authentication information on the external website, host website server 50 can transfer any required information, which is stored in database 54, or alternatively database 56, to the external website. The user may access the external website, for example, by making an HTTP request to access the external website, or by selecting an HTML link from the host website to the external website.

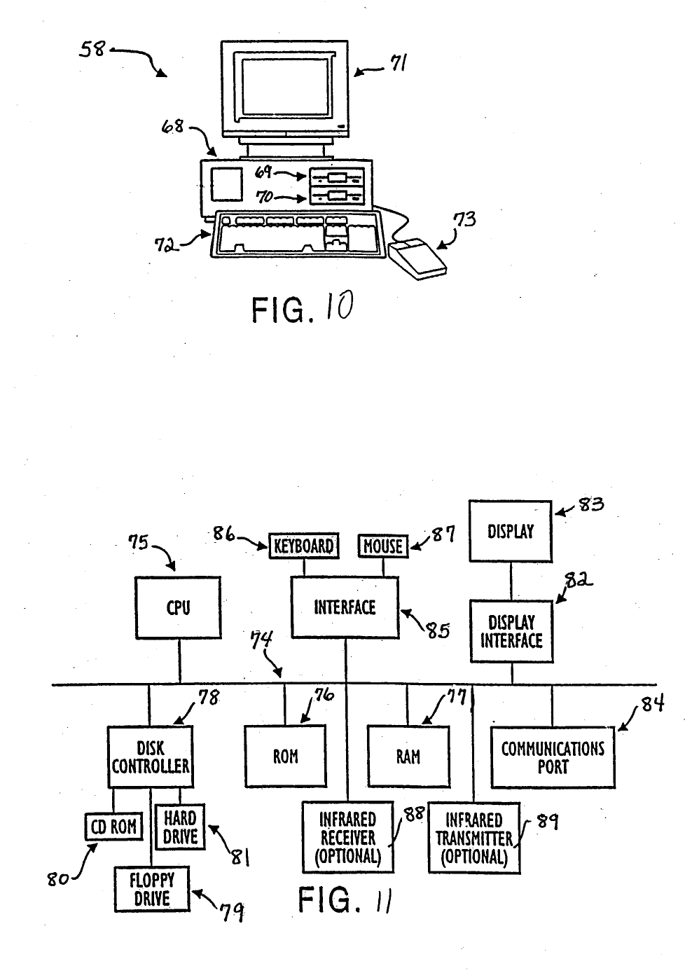

FIG. 8 illustrates the two methods in which the user may access the external website. In HTTP request method 220, an HTTP request to access the external website is received by host website server 50. Host website server 50 generates a secure connection 222 to external website server 62 and transfers the user information using, for example, Secure Sockets Layer (“SSL”) and a HTTP Post request protocol. The user is thus authenticated with external website server 62, and the HTTP request is redirected to external website server 62 from host server 50. By contrast, in HTML link method 230, the host website has an HTML link to the external website with query string parameters containing the user's information. The user clicks on the link to the external website and the user information required for authenticating the user with external website server 62 is transferred from host website server 50 to external website server 62 using SSL and a HTTP Get request protocol.

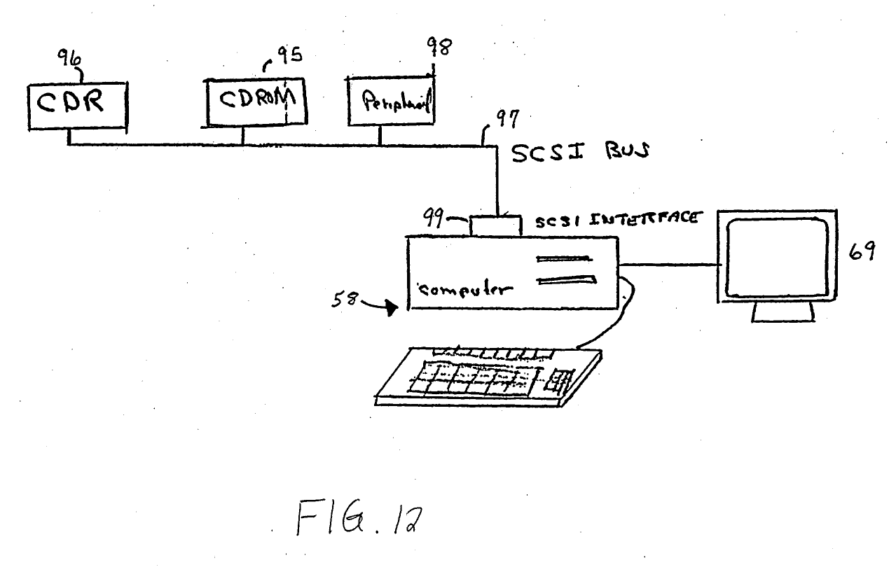

FIG. 9 illustrates a process for securely transferring user information from host website server 50 to external website server 62, denoted generally by reference number 240. The user initiates the process by clicking on a link to the external website or by making an HTTP request to visit an external website, step 242. Host website server 50 determines whether the user is logged in, step 244. If the user is not logged in, host website server 50 displays a popup message explaining to the user that the user must be currently logged in to the host website, step 246. The user is then redirected to a login page, step 248.

If the user is logged in, host website server is able to retrieve the user's information from database 54, or alternatively, database 56. Host website 50 then determines whether the user information is being sent by way of an HTTP Post message or an HTTP Get message, step 250. If the user requested access to the external website by clicking on an HTML link on the host website, the user information is sent to external website server 62 using the HTTP Get message protocol. Host website server 50 generates the HTTP Get message, which contains the user information required to authenticate the user with external website server 62, step 252. Once the user information has been sent, the user is redirected to the external website, step 254, and the user is authenticated with external website server 62 using the user information contained in the HTTP Get message, step 256. The external website is then displayed to the user on user terminal 52, step 270.

If the user requested access to the external website using an HTTP request, the user information is sent to external website server 62 using the HTTP Post message protocol. Host website server 50 generates the HTTP Post message, which contains the user information required to authenticate the user with external website server 62, step 260. The user information is transferred to external website server 62 using Java Secure Socket Extensions (“JSSE”) over HTTP, and the user is authenticated with external website server 62, step 262. External website server 62 generates and transfers a home page of the external website to host website server 50 using JSSE over HTTP, step 264. Host website server 266 displays the home page of the external website to the user on user terminal 52, step 266. The user may then access any link on the home page of the external website, step 268, and the requested resource is displayed to the user, step 270.

FIG. 10 is an illustration of a computer 58 used for implementing the computer processing in accordance with a computer-implemented embodiment of the present invention. The procedures described above may be presented in terms of program procedures executed on, for example, a computer or network of computers.

Viewed externally in FIG. 10, computer 58 has a central processing unit (CPU) 68 having disk drives 69, 70. Disk drives 69, 70 are merely symbolic of a number of disk drives that might be accommodated by computer 58. Typically, these might be one or more of the following: a floppy disk drive 69, a hard disk drive (not shown), and a CD ROM or digital video disk, as indicated by the slot at 70. The number and type of drives varies, typically with different computer configurations. Disk drives 69, 70 are, in fact, options, and for space considerations, may be omitted from the computer system used in conjunction with the processes described herein.

Computer 58 also has a display 71 upon which information may be displayed. The display is optional for the computer used in conjunction with the system described herein. A keyboard 72 and/or a pointing device 73, such as a mouse 73, may be provided as input devices to interface with central processing unit 68. To increase input efficiency, keyboard 72 may be supplemented or replaced with a scanner, card reader, or other data input device. The pointing device 73 may be a mouse, touch pad control device, track ball device, or any other type of pointing device.

Alternatively, referring to FIG. 12, computer 58 may also include a CD ROM reader 95 and CD recorder 96, which are interconnected by a bus 97 along with other peripheral devices 98 supported by the bus structure and protocol. Bus 97 serves as the main information highway interconnecting other components of the computer. It is connected via an interface 99 to the computer 58.

FIG. 11 illustrates a block diagram of the internal hardware of the computer of FIG. 10. CPU 75 is the central processing unit of the system, performing calculations and logic operations required to execute a program. Read only memory (ROM) 76 and random access memory (RAM) 77 constitute the main memory of the computer. Disk controller 78 interfaces one or more disk drives to the system bus 74. These disk drives may be floppy disk drives such as 79, or CD ROM or DVD (digital video/versatile disk) drives, as at 80, or internal or external hard drives 81. As previously indicated these various disk drives and disk controllers are optional devices.

A display interface 82 permits information from bus 74 to be displayed on the display 83. Again, as indicated, the display 83 is an optional accessory for a central or remote computer in the communication network, as are infrared receiver 88 and transmitter 89. Communication with external devices occurs using communications port 84.

In addition to the standard components of the computer, the computer may also include an interface 85, which allows for data input through the keyboard 86 or pointing device, such as a mouse 87.

The foregoing detailed description includes many specific details. The inclusion of such detail is for the purpose of illustration only and should not be understood to limit the invention. In addition, features in one embodiment may be combined with features in other embodiments of the invention. Various changes may be made without departing from the scope of the invention as defined in the following claims.

As one example, the system according to the invention may include a general purpose computer, or a specially programmed special purpose computer. The user may interact with the system via e.g., a personal computer or over PDA, e.g., the Internet an Intranet, etc. Either of these may be implemented as a distributed computer system rather than a single computer. Similarly, the communications link may be a dedicated link, a modem over a POTS line, and/or any other method of communicating between computers and/or users. Moreover, the processing could be controlled by a software program on one or more computer systems or processors, or could even be partially or wholly implemented in hardware.

The user interfaces may be developed in connection with an HTML display format. Although HTML is utilized in the illustrated examples, it is possible to utilize alternative technology for displaying information, obtaining user instructions and for providing user interfaces. The invention has been discussed in connection with particular examples. However, the principles apply equally to other examples and/or realizations. Naturally, the relevant data may differ, as appropriate.

Further, this invention has been discussed in certain examples as if it is made available to a single user. The invention may be used by numerous users, if preferred. The system used in connection with the invention may rely on the integration of various components including, as appropriate and/or if desired, hardware and software servers, database engines, and/or other content providers. The configuration may be, preferably, network-based and uses the Internet as a primary interface with the user.

The system according to one or more embodiments of the invention may store collected information and/or indexes to information in a database. An appropriate database may be on a standard server, for example, a small Sun™ Sparc™ or other remote location. The information may, for example, optionally be stored on a platform that may, for example, be UNIX-based. The various databases maybe in, for example, a UNIX format, but other standard data formats may be used.

Although the computer system in FIG. 10 is illustrated as having a single computer, the system according to one or more embodiments of the invention is optionally suitably equipped with a multitude or combination of processors or storage devices. For example, the computer may be replaced by, or combined with, any suitable processing system operative in accordance with the principles of embodiments of the present invention, including sophisticated calculators, hand held, laptop/notebook, mini, mainframe and super computers, as well as processing system network combinations of the same. Further, portions of the system may be provided in any appropriate electronic format, including, for example, provided over a communication line as electronic signals, provided on floppy disk, provided on CD Rom, provided on optical disk memory, etc.

Any presently available or future developed computer software language and/or hardware components can be employed in such embodiments of the present invention. For example, at least some of the functionality mentioned above could be implemented using Visual Basic, C, C++ or any assembly language appropriate in view of the processor being used. It could also be written in an interpretive environment such as Java and transported to multiple destinations to various users.

The many features and advantages of the invention are apparent from the detailed specification, and thus, it is intended by the appended claims to cover all such features and advantages of the invention, which fall within the true spirit and scope of the invention. Further, since numerous modifications and variations will readily occur to those skilled in the art, it is not desired to limit the invention to the exact construction illustrated and described, and accordingly, all suitable modifications and equivalence may be resorted to, falling within the scope of the invention.

What is claimed is:

1. A method of securely transferring user information between a website server and at least one external website server to authenticate a user with the at least one external website server, the method comprising at least one of the sequential, non-sequential, or sequence independent steps of:
receiving a request for accessing the at least one external website server by the user;
determining whether the user is not logged on to the website server;
if the user is not logged on, logging on to the website server by the user;
generating a secure connection from the website server to the at least one external website server; and
transferring the user information from the website server to the at least one external website server by at least one of a HTTP GET protocol and a HTTP POST protocol.

2. The method of claim 2, wherein the step of logging on further comprises:
displaying to the user a message that the user must be logged in;
redirecting the user to a login page;
prompting the user to enter a userID and a password;
matching the userID and the password entered by the user with user login information stored in a database; and
if the userID and the password match the user login information located in the database, logging in the user.

3. The method of claim 1, wherein the HTTP GET protocol is used to transfer the information from the website server to the at least one external website server, the method further comprising:
generating a HTTP GET message, wherein the HTTP GET message contains the user information required to authenticate the user with the at least one external website server;
redirecting the user to the at least one external website server;
authenticating the user with the at least one external website server, such that the user can access an external website supported by the at least one external website server; and
displaying the external website to the user.

4. The method of claim 3, wherein the request to access the at least one external website server is received by the user utilizing a HyperText Markup Language link to the external website located on a website supported by the website server.

5. The method of claim 3, wherein the HTTP GET message is transferred using Secure Sockets Layer security protocol.

6. The method of claim 1, wherein the HTTP POST protocol is used to transfer the information from the website server to the at least one external website server, the method further comprising:
generating a HTTP POST message, wherein the HTTP POST message contains the user information required to authenticate the user with the at least one external website server;
transferring the HTTP POST message to the at least one external website server using a Java Secure Socket Extensions protocol;
authenticating the user with the at least one external website server, such that the user can access an external website supported by the at least one external website server;
generating the external website and transferring the external website to the website server suing the Java Secure Socket Extensions protocol; and
displaying the external website to the user.

7. The method of claim 6, wherein the request to access the at least one external website server is received by the user entering a HyperText Transport Protocol request to access the external website.

8. The method of claim 6, wherein the HTTP POST message is transferred using Secure Sockets Layer security protocol.

9. A system for securely transferring user information between a website and at least one external website to authenticate a user with the at least one external website, the system comprising:
a website server, wherein the website server supports the website;
at least one external website server, wherein the at least one external website server supports the at least one external website;
a wide area network, wherein the wide area network facilitates the transferring of user information between the website server and the at least one external website server;
means for allowing the user to provide the user information such that the user is capable of being authenticated with the website server;
a database, in data communication with the website server, wherein the database stores the user information; and
means for generating a secure connection between the website server to the at least one external website server and for transferring the user information from the website server to the 5at least one external website server by at least one of a HTTP GET protocol and a HTTP POST protocol.

10. The system of claim 9, wherein the database further stores user login information.

11. The system of claim 9, further comprising a login information database, wherein the login information database stores user login information.

12. A system for securely transferring user information between a website server and at least one external website server to authenticate a user with the at least one external website server, the system comprising:
means for receiving a request for accessing to the at least one external website server by the user;
means for determining whether the user is not logged on to the website server;
if the user is not logged on, means for logging on to the website server by the user;
means for generating a secure connection from the website server to the at least one external website server; and
means for transferring the user information from the website server to the at least one external website server by one of a HTTP GET protocol and a HTTP POST protocol.

13. The system of claim 12, further comprising:
means for displaying to the user a message that the user must be logged in;
means for redirecting the user to a login page;
means for prompting the user to enter a userID and a password; and
means for matching the userID and the password entered by the user with user login information stored in a database.

14. The system of claim 12, wherein the HTTP GET protocol is used to transfer the information from the website server to the at least one external website server, the system further comprising:
means for generating a HTTP GET message, wherein the HTTP GET message contains the user information required to authenticate the user with the at least one external website server;
means for redirecting the user to the at least one external website server;
means for authenticating the user with the at least one external website server, such that the user can access an external website supported by the at least one external website server; and
means for displaying the external website to the user.

15. The system of claim 14, wherein the request to access the at least one external website server is received by the user clicking on a HyperText Markup Language link to the external website located on a website supported by the website server.

16. The system of claim 14, wherein the HTTP GET message is transferred using Secure Sockets Layer security protocol.

17. The system of claim 12, wherein the HTTP POST protocol is used to transfer the information from the website server to the at least one external website server, the method further comprising:
means for generating a HTTP POST message, wherein the HTTP POST message contains the user information required to authenticate the user with the at least one external website server;
means for transferring the HTTP POST message to the at least one external website server using a Java Secure Socket Extensions protocol;
means for authenticating the user with the at least one external website server, such that the user can access an external website supported by the at least one external website server;
means for generating the external website and transferring the external website to the home website server suing the Java Secure Socket Extensions protocol; and
means for displaying the external website to the user.

18. The system of claim 17, wherein the request to access the at least one external website server is received by the user entering a HyperText Transport Protocol request to access the external website.

19. The system of claim 17, wherein the HTTP POST message is transferred using Secure Sockets Layer security protocol.

20. A system for securely transferring user information between a website and at least one external website to authenticate a user with the at least one external website, the system comprising:
a website server, wherein the website server supports the website;
at least one external website server, wherein the at least one external website server supports the at least one external website;
a wide area network, wherein the wide area network facilitates the transferring of user information between the website server and the at least one external website server, provides a secure connection between the website server to the at least one external website server, and enables the transfer of the user information from the website server to the at least one external website server by at least one of a HTTP GET protocol and a HTTP POST protocol;
a user input that enables the user to provide the user information such that the user is capable of being authenticated with the website server; and
a database, in data communication with the website server, wherein the database stores the user information.

21. The system of claim 20, wherein the database further stores user login information.

22. The system of claim 20, further comprising a login information database, wherein the login information database stores user login information.
